(19) United States
(12) Patent Application Publication
(10) Pub. No.: US 2019/0372245 A1
(43) Pub. Date: Dec. 5, 2019

(54) ELECTRIC WIRE WITH TERMINAL AND METHOD OF MANUFACTURING ELECTRIC WIRE WITH TERMINAL

(71) Applicant: Yazaki Corporation, Tokyo (JP)

(72) Inventors: Tomoya Sato, Shizuoka (JP); Naoki Ito, Shizuoka (JP); Yasunori Nabeta, Shizuoka (JP)

(21) Appl. No.: 16/402,181

(22) Filed: May 2, 2019

(30) Foreign Application Priority Data
Jun. 4, 2018 (JP) 2018-106718

(51) Int. Cl. H01R 4/18; H01R 4/2495; H01R 4/20; H01R 43/048

(52) U.S. Cl. CPC H01R 4/185; H01R 43/048; H01R 4/20; H01R 4/2495

(57) ABSTRACT

An electric wire with terminal includes: an electric wire including a core wire having a plurality of element wires, and a covering that covers the core wire in a state in which an end portion of the core wire is exposed; and a crimp terminal including a core wire crimping portion crimped to a part of the end portion of the core wire on the covering side, and a swaging portion swaged to a part of the end portion of the core wire closer to a distal end than the core wire crimping portion. The core wire has a cutting surface formed by cutting a part of the element wires. The cutting surface is adjacent to the swaging portion, and is opposed to a side surface of the swaging portion in an axial direction of the electric wire. Adjacent element wires are bonded at the cutting surface.

### CROSS-REFERENCE TO RELATED APPLICATION(S)

The present application claims priority to and incorporates by reference the entire contents of Japanese Patent Application No. 2018-106718 filed in Japan on Jun. 4, 2018.

### BACKGROUND OF THE INVENTION

### 1. Field of the Invention

The present invention relates to an electric wire with terminal and a method of manufacturing an electric wire with terminal.

### 2. Description of the Related Art

Conventionally, electric wires with terminals are known. Japanese Patent Application Laid-open No. 2010-225529 discloses a technology of an electric wire with a terminal metal fitting, in which a terminal metal fitting is attached to a terminal portion of an electric wire having a core wire formed by stranding a plurality of metal element wires, and a cutting end surface of the core wire is soldered. In Japanese Patent Application Laid-open No. 2010-225529, the terminal portion of the core wire is soldered by a flow method in which the terminal portion is dipped in a solder tank storing molten solder therein.

It is desired for an electric wire with terminal that electric performance be improved with a simple configuration. For example, the configuration can be simplified if an electric resistance can be reduced without adding an additional material such as solder or an additional member.

### SUMMARY OF THE INVENTION

It is an object of the present invention to provide an electric wire with terminal and a method of manufacturing an electric wire with terminal, which are capable of improving electric performance with a simple configuration.

An electric wire with terminal according to one aspect of the present invention includes an electric wire including a core wire having a plurality of element wires, and a covering that covers the core wire in a state in which an end portion of the core wire is exposed; and a crimp terminal including a core wire crimping portion crimped to a part of the end portion of the core wire on the covering side, and a swaging portion swaged to a part of the end portion of the core wire closer to a distal end of the core wire than the core wire crimping portion, wherein the core wire has a cutting surface formed by cutting a part of the element wires, the cutting surface is adjacent to the swaging portion, and is opposed to a side surface of the swaging portion in an axial direction of the electric wire, and adjacent ones of the element wires are bonded at the cutting surface.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of an electric wire with terminal according to a first embodiment;

FIG. 2 is a plan view of an electric wire according to the first embodiment;

FIG. 3 is a diagram for describing a removal step in the first embodiment;

FIG. 4 is a front view of the electric wire according to the first embodiment;

FIG. 5 is a plan view of a crimp terminal according to the first embodiment;

FIG. 6 is a front view for describing an installation step in the first embodiment;

FIG. 7 is a cross-sectional view for describing the installation step in the first embodiment;

FIG. 8 is a front view for describing a cutting step in the first embodiment;

FIG. 9 is a cross-sectional view for describing a crimping step and the cutting step in the first embodiment;

FIG. 10 is a cross-sectional view for describing the cutting step in the first embodiment;

FIG. 11 is a side view illustrating a cutting surface of the electric wire with terminal according to the first embodiment;

FIG. 12 is a perspective view of the electric wire with terminal according to the first embodiment;

FIG. 13 is a cross-sectional view of a swaging portion according to the first embodiment;

FIG. 14 is a cross-sectional view of a core wire crimping portion according to the first embodiment;

FIG. 15 is a cross-sectional view illustrating a swaging shape of a swaging portion according to a first modification of the first embodiment;

FIG. 16 is a cross-sectional view illustrating another example of the swaging shape;

FIG. 17 is a cross-sectional view illustrating still another example of the swaging shape;

FIG. 18 is a cross-sectional view for describing a cutting step according to a second modification of the first embodiment;

FIG. 19 is a cross-sectional view of a terminal crimping apparatus and a crimp terminal according to a second embodiment;

FIG. 20 is a cross-sectional view for describing a crimping step and a cutting step according to the second embodiment; and

FIG. 21 is a cross-sectional view for describing a cutting step according to the second embodiment.

### DETAILED DESCRIPTION OF THE PREFERRED EMBODIMENTS

Referring to the accompanying drawings, an electric wire with terminal and a method of manufacturing an electric wire with terminal according to embodiments of the present invention are described in detail below. The present invention is not limited by the embodiments. Components in the following embodiments include the ones that can be easily conceived by a person skilled in the art and the ones that are substantially the same.

### First Embodiment

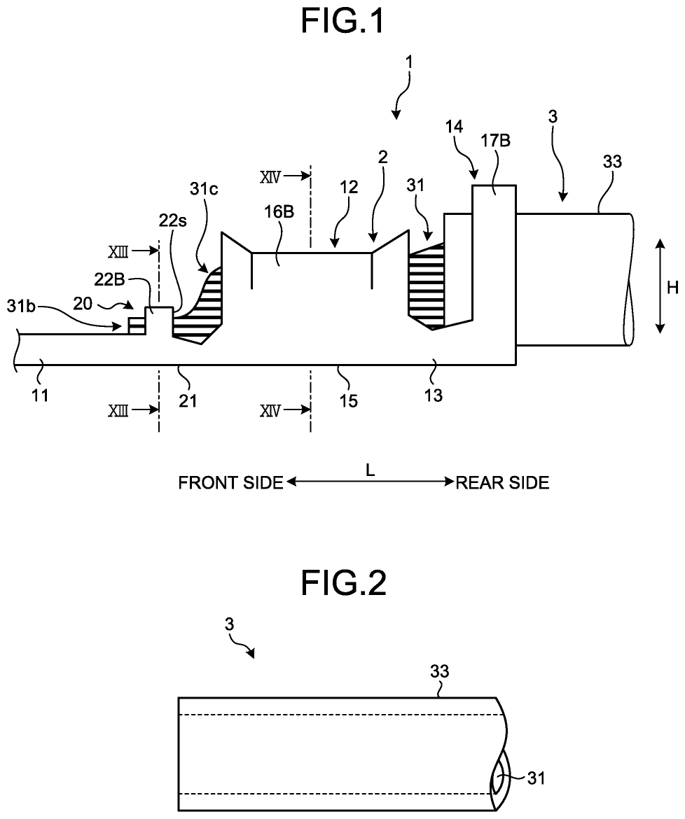

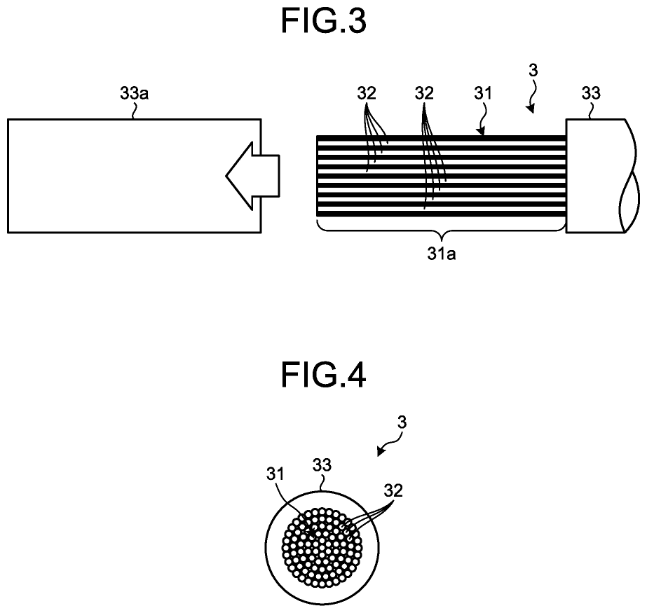

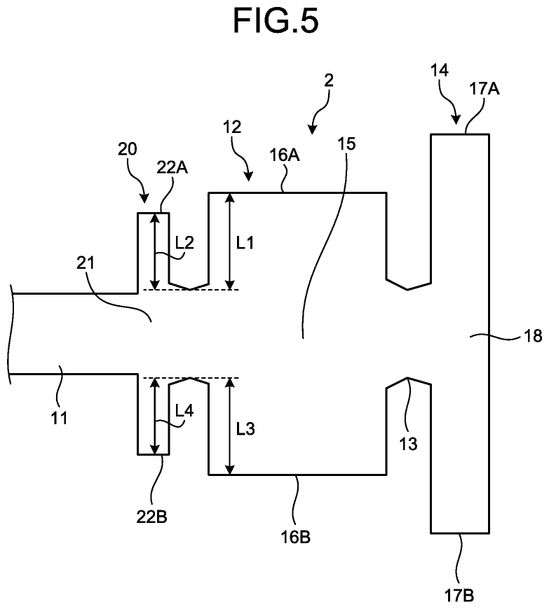

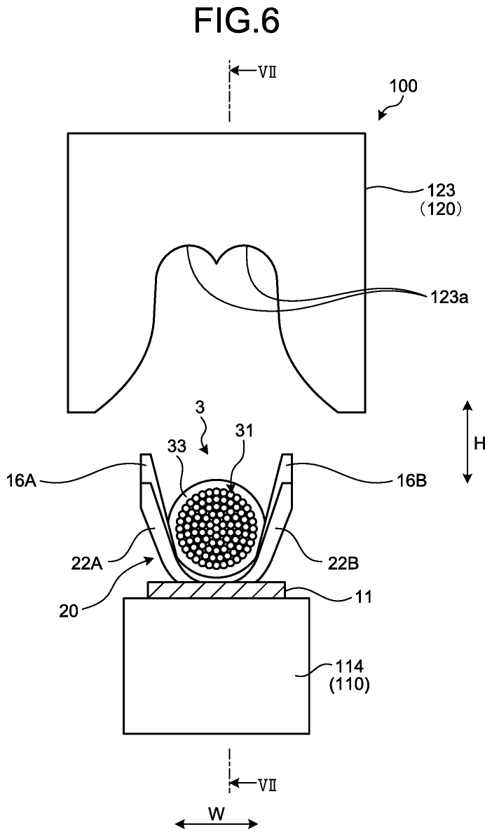

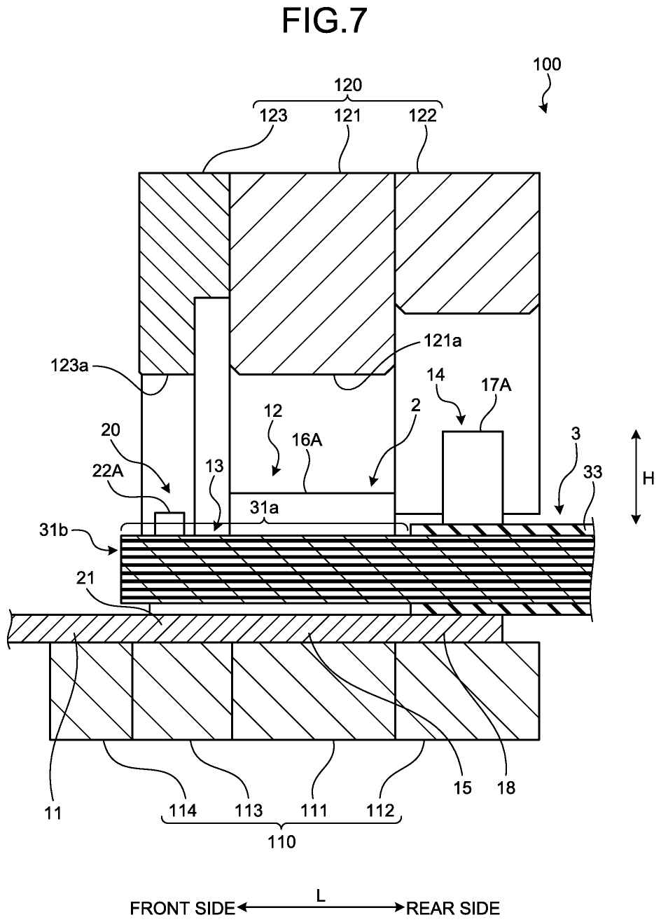

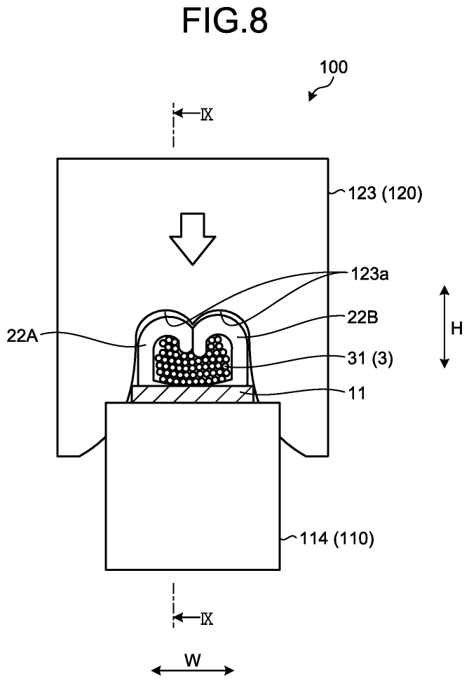

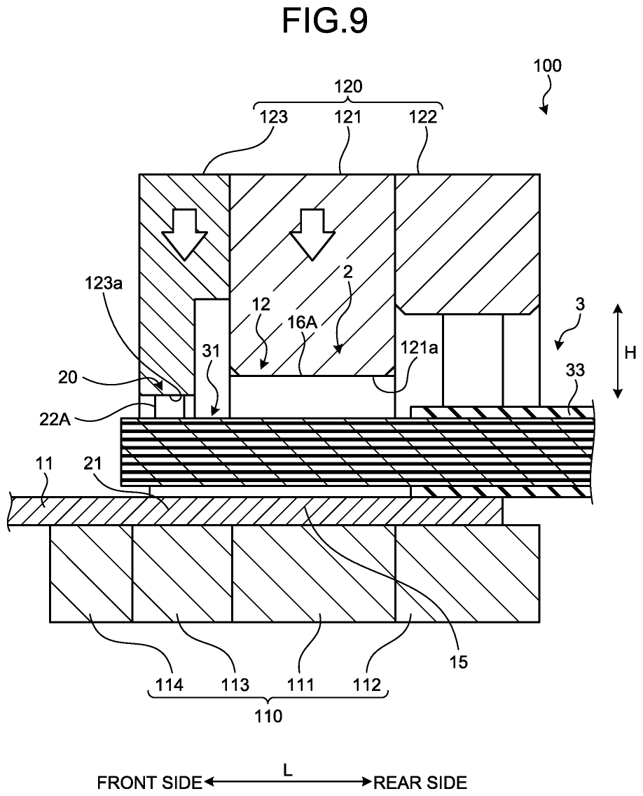

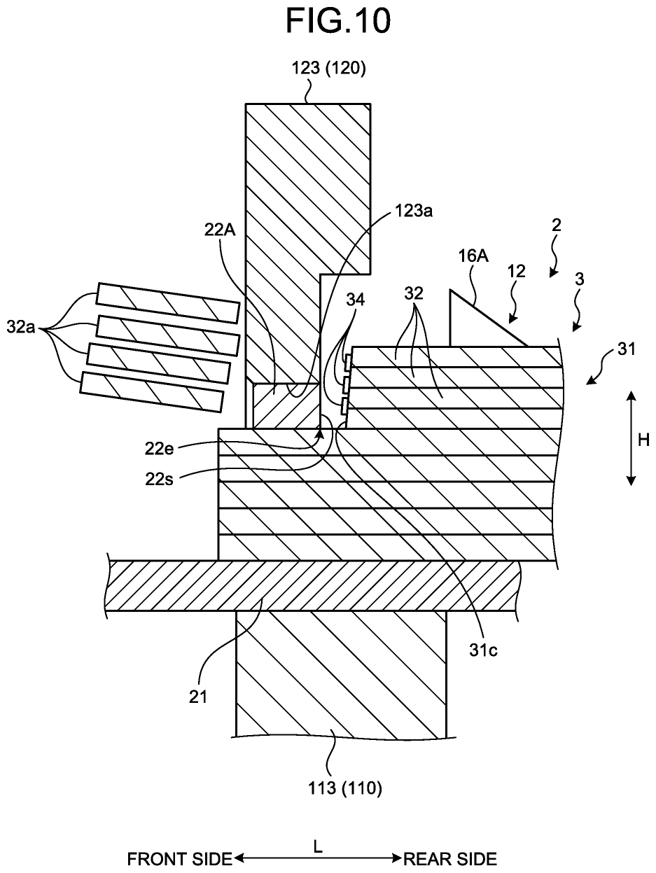

Referring to FIG. 1 to FIG. 14, a first embodiment is described. The first embodiment relates to an electric wire with terminal and a method of manufacturing an electric wire with terminal. FIG. 1 is a side view of the electric wire with terminal according to the first embodiment. FIG. 2 is a plan view of an electric wire according to the first embodiment. FIG. 3 is a diagram for describing a removal step in the first embodiment. FIG. 4 is a front view of the electric wire according to the first embodiment. FIG. 5 is a plan view of a crimp terminal according to the first embodiment. FIG. 6 is a front view for describing an installation step in the first embodiment. FIG. 7 is a cross-sectional view for describing the installation step in the first embodiment. FIG. 8 is a front view for describing a cutting step in the first embodiment. FIG. 9 is a cross-sectional view for describing a crimping step and a cutting step in the first embodiment. FIG. 10 is a cross-sectional view for describing the cutting step in the first embodiment.

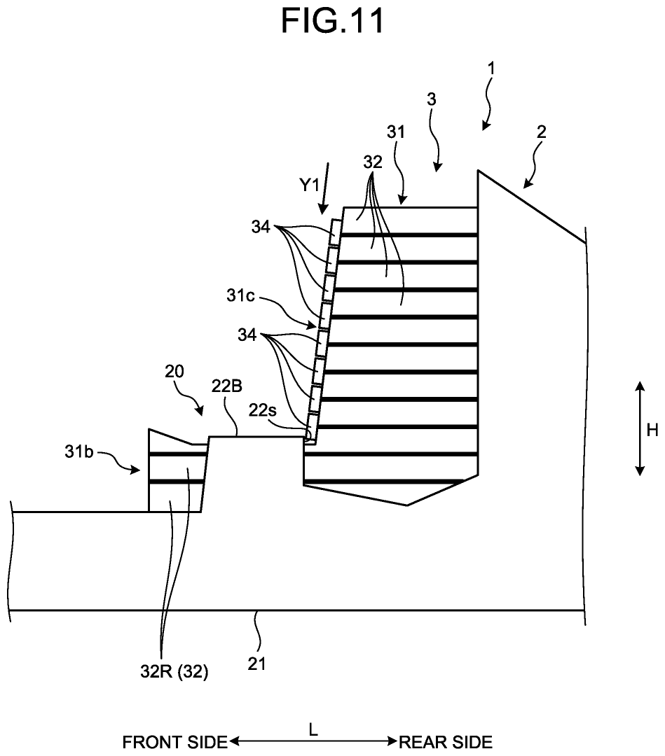

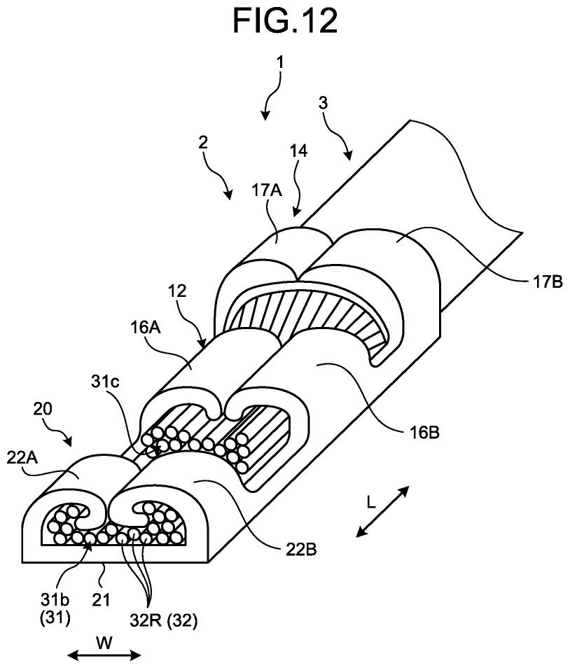

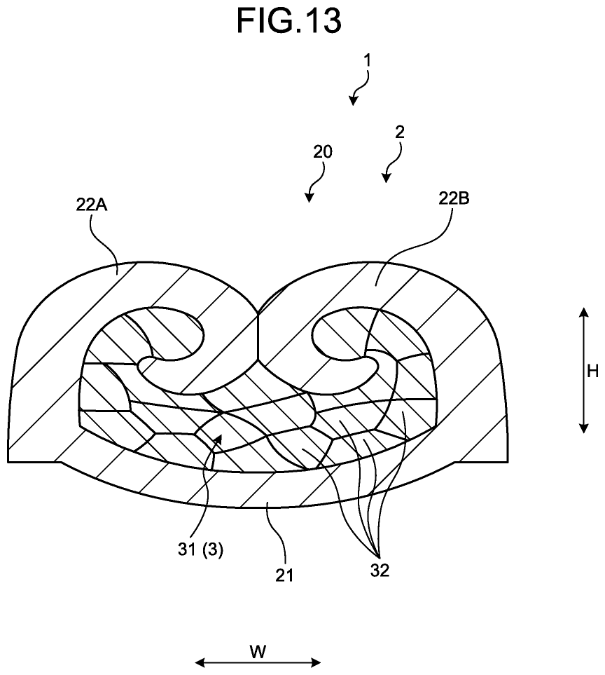

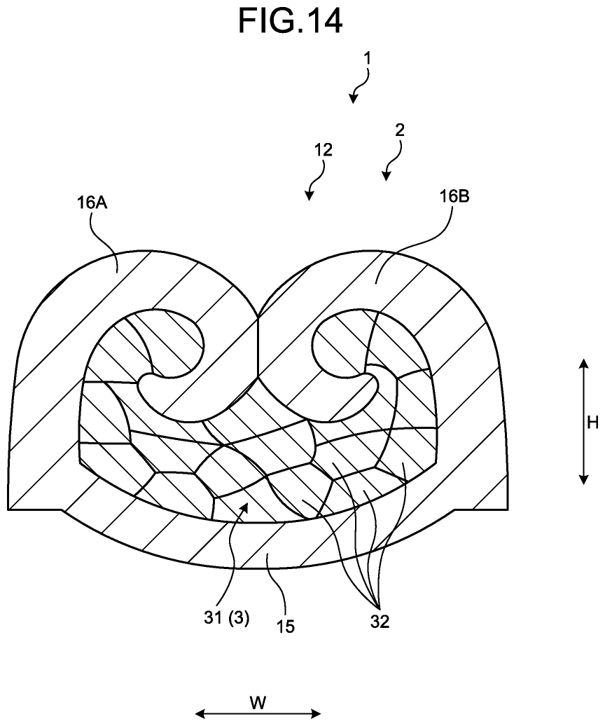

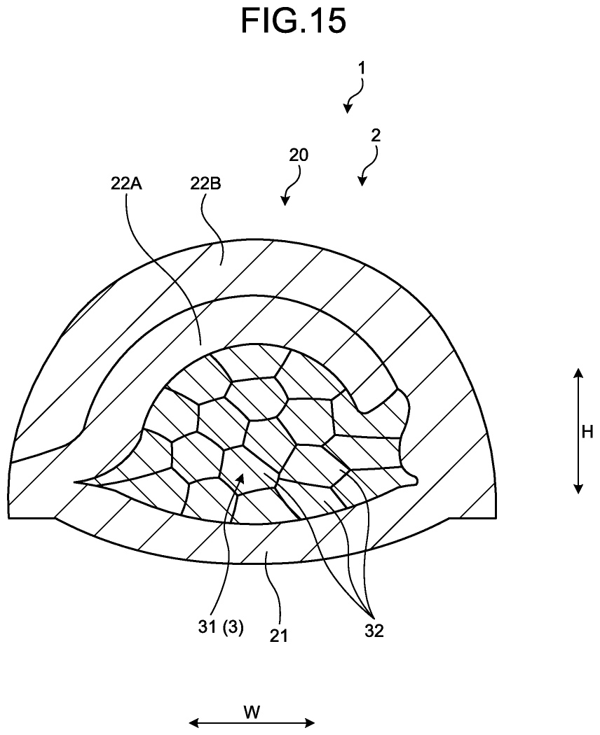

FIG. 11 is a side view illustrating a cutting surface of the electric wire with terminal according to the first embodiment. FIG. 12 is a perspective view of the electric wire with terminal according to the first embodiment. FIG. 13 is a cross-sectional view of a swaging portion according to the first embodiment. FIG. 14 is a cross-sectional view of a core wire crimping portion according to the first embodiment. FIG. 7 illustrates a cross section taken along line VII-VII in FIG. 6. FIG. 9 illustrates a cross section taken along line IX-IX in FIG. 8. FIG. 13 illustrates a cross section taken along line XIII-XIII in FIG. 1. FIG. 14 illustrates a cross section taken along line XIV-XIV in FIG. 1.

As illustrated in FIG. 1, an electric wire with terminal 1 according to the first embodiment includes a crimp terminal 2 and an electric wire 3. The crimp terminal 2 is a terminal to be crimped to the electric wire 3. The crimp terminal 2 is electrically connected to a counterpart terminal (not shown) while being integrated with the electric wire 3. In the electric wire 3 to be crimped, a covering 33 is removed at an end portion thereof, and a predetermined length of a core wire 31 is exposed. The core wire 31 in the first embodiment is a collection of a plurality of element wires 32. The element wires 32 are formed by conductive metal, such as copper and aluminum. The crimp terminal 2 is crimped to an end portion of the electric wire 3 and is thus electrically connected to the exposed core wire 31.

The crimp terminal 2 is formed from a conductive metal plate (for example, a copper plate or copper alloy plate) as base metal. The crimp terminal 2 is formed into a predetermined shape that can be connected to a counterpart terminal or an electric wire 3 by punching or bending of the base metal. The crimp terminal 2 has a coupling portion 11, a swaging portion 20, a core wire crimping portion 12, a coupling portion 13, and a covering crimping portion 14.

In the following description, the longitudinal direction of the crimp terminal 2 is referred to as “first direction L”. The first direction L is an insertion direction of the crimp terminal 2 and a counterpart terminal and is an axial direction of the electric wire 3. The width direction of the crimp terminal 2 is referred to as “second direction W”. The second direction W is a direction orthogonal to the first direction L. A direction orthogonal to both the first direction L and the second direction W is referred to as “third direction H”. The third direction H is a height direction of the crimp terminal 2. The third direction H is a direction in which the core wire crimping portion 12 is pressed by a first die 110 and a second die 120 at a crimping step described later. In the first direction L, the distal end side of the core wire 31 is referred to as “front side”, and the side opposite to the front side is referred to as “rear side”.

The coupling portion 11, the swaging portion 20, the core wire crimping portion 12, the coupling portion 13, and the covering crimping portion 14 are arranged along the first direction L in this order. The coupling portion 11 is disposed in the front part of the crimp terminal 2. The swaging portion 20 is swaged to the core wire 31. The core wire crimping portion 12 is crimped to the core wire 31 at a position closer to the covering 33 than the swaging portion 20. The covering crimping portion 14 is crimped to the covering 33 of the electric wire 3. The core wire crimping portion 12 and the covering crimping portion 14 are continuous through the coupling portion 13. The coupling portion 11 extends from the swaging portion 20 to the front side.

The swaging portion 20 has a bottom portion 21 and a pair of swaging pieces 22A and 22B (see FIG. 12). The swaging pieces 22A and 22B are pieces extending from ends of the bottom portion 21. The core wire crimping portion 12 has a bottom portion 15 and a pair of swaging pieces 16A and 16B. The pair of swaging pieces 16A and 16B are pieces extending from ends of the bottom portion 15. The covering crimping portion 14 has a pair of swaging pieces 17A and 17B.

The core wire crimping portion 12 is crimped to a part of the exposed core wire 31 on the covering 33 side. The swaging portion 20 is swaged to a part of the exposed core wire 31 closer to a distal end 31b than the core wire crimping portion 12. The core wire 31 in the first embodiment has a cutting surface 31c. The cutting surface 31c is formed between the swaging portion 20 and the core wire crimping portion 12. The cutting surface 31c is a surface formed by cutting the element wire 32 by the swaging portion 20. The cutting surface 31c is adjacent to the swaging portion 20 in the first direction L. The cutting surface 31c is opposed to a rear side surface 22s of the swaging portion 20 in the first direction L. The cutting surface 31c has a bonding portion 34 (see FIG. 11) at which adjacent element wires 32 are bonded. In the electric wire with terminal 1 in the first embodiment, the element wires 32 are metal-bonded together, and hence the electric performance improves.

Now, a method of manufacturing an electric wire with terminal according to the first embodiment is described in detail. The method of manufacturing an electric wire with terminal according to the first embodiment includes a removal step, installation step, a cutting step, and a crimping step.

Removal Step

The removal step is a step for removing a part of the covering 33 from the electric wire 3 to expose the core wire 31. FIG. 2 illustrates the electric wire 3 before a part of the covering 33 is removed. In the electric wire 3 illustrated in FIG. 2, the entire core wire 31 excluding an end surface of the core wire 31 is covered by covering 33. As illustrated in FIG. 3, at the removal step, a terminal portion 33a of the covering 33 is removed from the electric wire 3. When the terminal portion 33a is removed, an end portion 31a of the core wire 31 is exposed from the covering 33. For example, the cross-sectional shape of the core wire 31 and the cross-sectional shape of each element wire 32 are circular as illustrated in FIG. 4. The cross- sectional shape of the core wire 31 and the cross-sectional shape of the element wire 32 are not limited to be circular.

Installation Step

The installation step is a step for installing the electric wire 3 on the crimp terminal 2. The crimp terminal 2 is formed into a flat plate shape illustrated in FIG. 5, and then the crimp terminal 2 is bent into a U shape as illustrated in FIG. 6. More specifically, the crimp terminal 2 is bent such that a bottom portion 15 of the core wire crimping portion 12 serves as a U-shaped bottom wall and the swaging pieces 16A and 16B of the core wire crimping portion 12 serve as side walls. The crimp terminal 2 is bent such that a bottom portion 21 of the swaging portion 20 serves as a U-shaped bottom wall and the swaging pieces 22A and 22B of the swaging portion 20 serve as side walls. As illustrated in FIG. 5, a length L1 of the first swaging piece 16A of the core wire crimping portion 12 is larger than a length L2 of the first swaging piece 22A of the swaging portion 20. A length L3 of the second swaging piece 16B is larger than a length L4 of the second swaging piece 22B.

At the installation step, the crimp terminal 2 and the electric wire 3 are installed on the first die 110 in a terminal crimping apparatus 100. As illustrated in FIG. 6 and FIG. 7, the terminal crimping apparatus 100 includes a first die 110 and a second die 120. The first die 110 is a fixed die, and supports the crimp terminal 2. The second die 120 is a movable die, and moves in the vertical direction relative to the first die 110.

As illustrated in FIG. 7, the first die 110 includes a first anvil 111, a second anvil 112, a third anvil 113, and a fourth anvil 114. The first anvil 111 supports the core wire crimping portion 12. The second anvil 112 supports the covering crimping portion 14. The third anvil 113 supports the swaging portion 20. The fourth anvil 114 supports the coupling portion 11 and a terminal connecting portion (not shown). The terminal connecting portion is a part of the crimp terminal 2 to be connected to a counterpart terminal. The terminal connecting portion is continuous to the swaging portion 20 through the coupling portion 11.

The second die 120 includes a first crimper 121, a second crimper 122, and a third crimper 123. The first crimper 121 is opposed to the first anvil 111. The first crimper 121 swages the core wire crimping portion 12 to crimp the core wire crimping portion 12 to the core wire 31. The second crimper 122 is opposed to the second anvil 112. The second crimper 122 swages the covering crimping portion 14 to crimp the covering crimping portion 14 to the covering 33. The third crimper 123 is opposed to the third anvil 113. The third crimper 123 swages the swaging portion 20 to the core wire 31 to form a cutting surface 31c in the core wire 31.

At the installation step, the crimp terminal 2 formed into a U shape is placed on the top surface of the first die 110. As illustrated in FIG. 7, the crimp terminal 2 is placed on the first die 110 such that the core wire crimping portion 12 is opposed to the first anvil 111, the covering crimping portion 14 is opposed to the second anvil 112, and the swaging portion 20 is opposed to the third anvil 113. More specifically, the crimp terminal 2 is placed such that the bottom portion 15 is supported by the first anvil 111 and the distal ends of the pair of swaging pieces 16A and 16B are opposed to the first crimper 121. The crimp terminal 2 is placed such that the bottom portion 21 is supported by the third anvil 113 and the distal ends of the pair of swaging pieces 22A and 22B are opposed to the third crimper 123.

The electric wire 3 is installed on the crimp terminal 2 supported by the first die 110. The electric wire 3 is installed on the crimp terminal 2 such that the end portion 31a of the core wire 31 is opposed to the bottom portion 15 of the core wire crimping portion 12 and the bottom portion 21 of the swaging portion 20, and the covering 33 is opposed to a bottom portion 18 of the covering crimping portion 14. For example, the electric wire 3 is installed such that the distal end 31b protrudes from the swaging portion 20 to the front side. The electric wire 3 may be installed such that the distal end 31b is opposed to the swaging portion 20.

Crimping Step

In the method of manufacturing an electric wire with terminal according to the first embodiment, the crimping step and the cutting step described later are performed in parallel. First, the crimping step is described. The crimping step is a step for crimping the core wire crimping portion 12 to the core wire 31. At the crimping step, the core wire crimping portion 12 is crimped to the core wire 31, and the covering crimping portion 14 is crimped to the covering 33. At the crimping step, the crimp terminal 2 and the electric wire 3 are sandwiched between the first die 110 and the second die 120. The first die 110 and the second die 120 crimp the swaging pieces 16A and 16B to the core wire 31, and crimp the swaging pieces 17A and 17B to the covering 33. At the crimping step, the second die 120 moves downward toward the first die 110.

The first crimper 121 has a curved surface 121a for deforming the swaging pieces 16A and 16B. The core wire crimping portion 12 in the first embodiment is crimped to the core wire 31 in a form called “B crimp” (see FIG. 14). The curved surface 121a deforms the swaging pieces 16A and 16B into a curved shape such that the distal ends of the swaging pieces 16A and 16B face the first die 110. The first crimper 121 deforms the swaging pieces 16A and 16B such that the core wire 31 is wrapped by the pair of swaging pieces 16A and 16B and the bottom portion 15. The covering crimping portion 14 in the first embodiment is crimped to the covering 33 in a form called “B crimp”.

Cutting Step

The cutting step is a step for cutting the element wires 32 of the core wire 31 by the swaging portion 20. When the second die 120 processes the element wires 32 at the crimping step, the third crimper 123 deforms the first swaging piece 22A and the second swaging piece 22B such that the first swaging piece 22A and the second swaging piece 22B are swaged to the core wire 31. As illustrated in FIG. 6 and FIG. 8, the third crimper 123 has curved surfaces 123a for deforming the swaging pieces 22A and 22B. The swaging portion 20 in the first embodiment is swaged to the core wire 31 in a form called “B crimp” (see FIG. 12 and FIG. 13). As illustrated in FIG. 9, when compared in the same cross section, the curved surfaces 123a of the third crimper 123 are located below the curved surface 121a of the first crimper 121.

The curved surfaces 123a deform the swaging pieces 22A and 22B into a curved shape such that the distal ends of the swaging pieces 22A and 22B face the first die 110. The third crimper 123 deforms the swaging pieces 22A and 22B such that the core wire 31 is wrapped by the pair of swaging pieces 22A and 22B and the bottom portion 21. FIG. 8 and FIG. 9 illustrate a state in which the third crimper 123 is deforming the swaging portion 20. When the third crimper 123 further descends from the state illustrated in FIG. 8, the swaging portion 20 cuts the element wires 32 as described later with reference to FIG. 10.

As illustrated in FIG. 10, the first swaging piece 22A cuts the element wires 32 by an edge portion 22e thereof. The cross-sectional shape of the first swaging piece 22A in the first embodiment is rectangle. The edge portion 22e is a corner of the first swaging piece 22A, and more specifically, a corner on the rear side in the first direction L and on the inner side. In other words, the edge portion 22e is an end portion of the side surface 22s of the first swaging piece 22A on the bottom portion 21 side. The first swaging piece 22A compresses the element wires 32 toward the bottom portion 21 to cause shear failure on the element wires 32. Shear failure occurs at a part of the element wire 32 that is in contact with the edge portion 22e and its vicinity. The element wire 32 is cut due to the shear failure, and a distal end portion 32a of the element wire 32 is removed. The first swaging piece 22A is swaged to the core wire 31 while cutting the element wires 32. The second swaging piece 22B is swaged to the core wire 31 while cutting the element wires 32 similarly to the first swaging piece 22A. After the element wires 32 are cut, a cutting surface 31c is formed on the core wire 31.

The first swaging piece 22A and the second swaging piece 22B pressurize the end portion of the element wire 32 while cutting the element wire 32, so that the end portion of the element wire 32 slidingly move with an end portion of an adjacent element wire 32. An oxide film of the element wire 32 is broken by the shear failure and the sliding of the element wire 32 with adjacent element wires 32, and a new surface of the element wire 32 is exposed. Thus, adjacent element wires 32 adheres and are bonded together. Accordingly, the bonding portion 34 is formed on at least the cutting surface 31c of the core wire 31. The outer peripheral surfaces of adjacent element wires 32 may adheres together to form the bonding portion 34. Adjacent element wires 32 are metal-bonded together at the bonding portion 34.

FIG. 11 and FIG. 12 illustrate a state in which the swaging of the swaging portion 20 to the core wire 31 has been completed. Element wires 32R, which are a part of the element wires 32 close to the bottom portion 21, are not cut but compressed by the swaging portion 20. In other words, the swaging portion 20 cuts most of the element wires 32 excluding the partial element wires 32R. For example, the swaging portion 20 may cut element wires 32 located at the radial center of the core wire 31. In other words, a group of element wires 32 that constitute a cutting surface 31c when being cut may include element wires 32 located at the center of the core wire 31. In this manner, the crimp terminal 2 is electrically connected to the element wires 32 at the center of the core wire 31 through the bonding portion 34.

The swaging portion 20 may cut at least a half of the element wires 32 included in the core wire 31. In this manner, the crimp terminal 2 is electrically connected to at least a half of the element wires 32 through the bonding portion 34.

The distal end of the cut element wire 32 may be sheared and deformed in a direction (direction of arrow Y1 in FIG. 11) toward the bottom portion 21 of the swaging portion 20 along the cutting surface 31c. At the cutting step, the swaging pieces 22A and 22B slidingly move on the cutting surface 31c, and shearing force in the direction of arrow Y1 acts on the element wire 32. The distal end of the element wire 32 may be sheared and deformed in the direction of arrow Y1 by the shearing force.

In the electric wire with terminal 1 in the first embodiment manufactured as described above, the element wires 32 are bonded together by the bonding portion 34. Thus, an electric resistance between the element wires 32 and an electric resistance between the core wire 31 and the crimp terminal 2 are reduced. Consequently, the electric wire with terminal 1 in the first embodiment can be improved in electric performance.

As described above, the electric wire with terminal 1 according to the first embodiment includes the electric wire 3 and the crimp terminal 2. The electric wire 3 includes the core wire 31 having the element wires 32, and the covering that covers the core wire 31 in the state in which the end portion 31a of the core wire 31 is exposed. The crimp terminal 2 includes the core wire crimping portion 12 and the swaging portion 20. The core wire crimping portion 12 is crimped to a part of the end portion 31a of the core wire 31 on the covering 33 side. The swaging portion 20 is swaged to a part of the end portion 31a of the core wire 31 closer to the distal end side than the core wire crimping portion 12.

The core wire 31 has a cutting surface obtained by cutting a part of the element wires 32. A cutting surface 31c is adjacent to the swaging portion 20, and is opposed to a side surface 22s of the swaging portion 20 in the axial direction of the electric wire 3. At the cutting surface 31c, adjacent element wires 32 are bonded. The element wires 32 are bonded together to reduce the electric resistance at the cutting surface 31c, and hence the electric performance of the electric wire with terminal 1 improves.

In the electric wire with terminal 1 in the first embodiment, the cutting surface 31c is formed by the swaging portion 20. In this case, a trace of cutting the element wire 32 may be left on the swaging pieces 22A and 22B of the swaging portion 20. For example, a trace of compression of the element wire 32 or a trace of sliding with an element wire 32 may be left on the edge portion 22e or the side surface 22s of the swaging pieces 22A and 22B. For example, when the edge portion 22e or the side surface 22s has streak formed by sliding with the element wire 32, it means that the cutting surface 31c has been formed by the method of manufacturing an electric wire with terminal according to the first embodiment.

In the electric wire with terminal 1 in the first embodiment, the distal end of the element wire 32 may be sheared and deformed in a direction toward the bottom portion 21 of the swaging portion 20 along the cutting surface 31c. In the core wire 31 in which the distal end of the element wire 32 is sheared and deformed as described above, the formation of the bonding portion 34 is promoted by the shearing deformation, and hence the electric performance improves.

In the electric wire with terminal in the first embodiment, the cutting surface 31c is a surface formed by cutting the element wires 32 by the swaging portion 20. Whether the element wires 32 have been cut by the swaging portion 20 can be confirmed by, for example, a trace such as streak formed on the edge portion 22e or the side surface 22s. When a part of the cut element wire 32 adheres to the edge portion 22e or the side surface 22s, it can be determined that the element wire 32 has been cut by the swaging portion 20.

The method of manufacturing an electric wire with terminal in the first embodiment includes the crimping step and the cutting step. The crimping step is a step for crimping the core wire crimping portion 12 of the crimp terminal 2 to a part of the end portion 31a of the core wire 31 of the electric wire 3 on the covering 33 side. The cutting step is a step for swaging the swaging portion 20 of the crimp terminal 2 to a part of the end portion 31a of the core wire 31 closer to the distal end 31b side than the core wire crimping portion 12 to cut a part of the element wires 32 by the swaging portion 20. At the cutting step, at least a part of the element wires 32 can be expected to be bonded together. Consequently, the method of manufacturing an electric wire with terminal according to the first embodiment can improve the electric performance of the electric wire with terminal 1.

The cutting step may also serve as a bonding step for bonding adjacent element wires 32. At the bonding step, the swaging portion 20 breaks an oxide film of the element wire 32 by at least one of the sliding of adjacent element wires 32 and the sliding of the swaging pieces 22A and 22B with the element wire 32, thereby bonding the element wires 32 together.

The cutting step is not necessarily required to be performed simultaneously with the crimping step. For example, the terminal crimping apparatus 100 may vertically move the third crimper 123 independently from the first crimper 121. As an example, the terminal crimping apparatus 100 may perform the cutting step by lowering the third crimper 123 while holding the first crimper 121 at the bottom dead center. Alternatively, the terminal crimping apparatus 100 may perform the cutting step by lowering the third crimper 123 when the first crimper 121 is raised after the crimping of the core wire crimping portion 12 is completed. Alternatively, after the crimping step is completed, the cutting step may be performed as a different step or by a different apparatus.

The crimping step and the cutting step may be performed after a plurality of electric wires 3 are installed on the crimp terminal 2. In this case, the terminal crimping apparatus 100 crimps the core wire crimping portion 12 to core wires 31 of the electric wires 3 at the crimping step. At the cutting step, the terminal crimping apparatus 100 cuts element wires 32 of the electric wires 3 by the swaging pieces 22A and 22B.

First Modification of First Embodiment

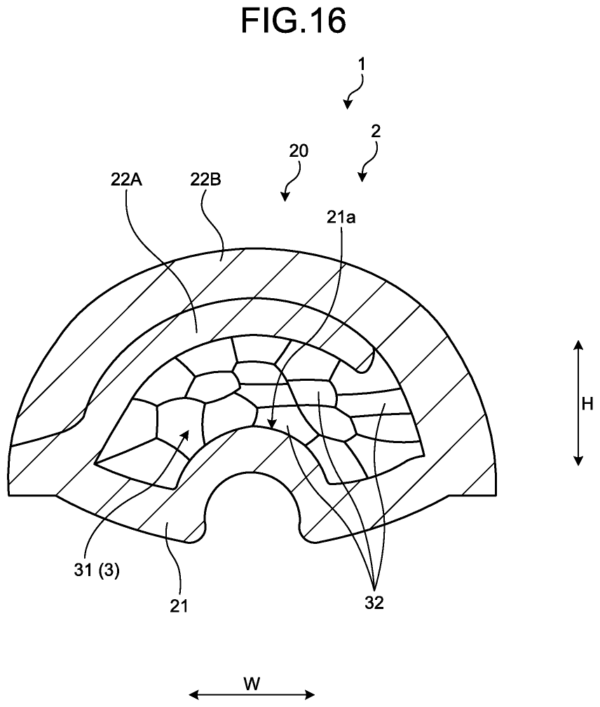

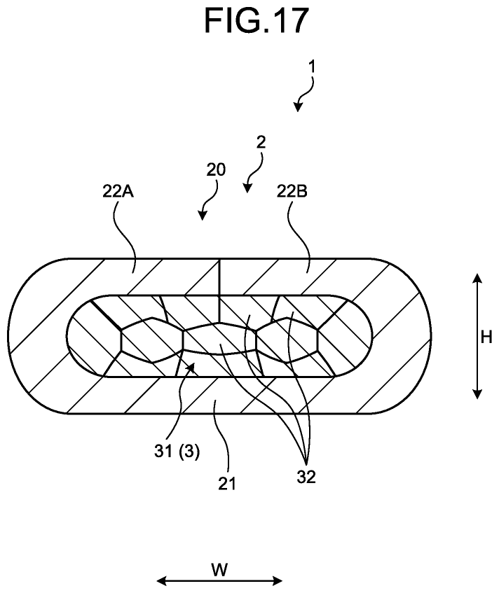

Modifications of the first embodiment are described. The swaging shape of the swaging portion 20 to the core wire 31 is not limited to the shape exemplified above in the first embodiment. FIG. 15 is a cross-sectional view illustrating a swaging shape of the swaging portion according to a first modification of the first embodiment. FIG. 16 is a cross-sectional view illustrating another example of the swaging shape. FIG. 17 is a cross-sectional view illustrating still another example of the swaging shape.

A swaging portion 20 illustrated in FIG. 15 is swaged to the core wire 31 while two swaging pieces 22A and 22B overlap each other. In the swaging portion 20 illustrated in FIG. 15, the second swaging piece 22B overlaps the outer side of the first swaging piece 22A. In the swaging portion 20 illustrated in FIG. 16, the two swaging pieces 22A and 22B overlap each other, and a protruding portion 21a is formed on the bottom portion 21. The protruding portion 21a protrudes toward the core wire 31. For forming the protruding portion 21a on the bottom portion 21, the third anvil 113 is provided with a protrusion for forming the protruding portion 21a. When the protruding portion 21a is formed, the adhesion between the bottom portion 21 and the core wire 31 is promoted.

A swaging portion 20 illustrated in FIG. 17 is swaged to the core wire 31 while distal ends of two swaging pieces 22A and 22B abut each other. The swaging portion 20 illustrated in FIG. 17 is swaged to the core wire 31 such that the distal end portions of the first swaging piece 22A and the second swaging piece 22B are parallel to the bottom portion 21.

Second Modification of First Embodiment

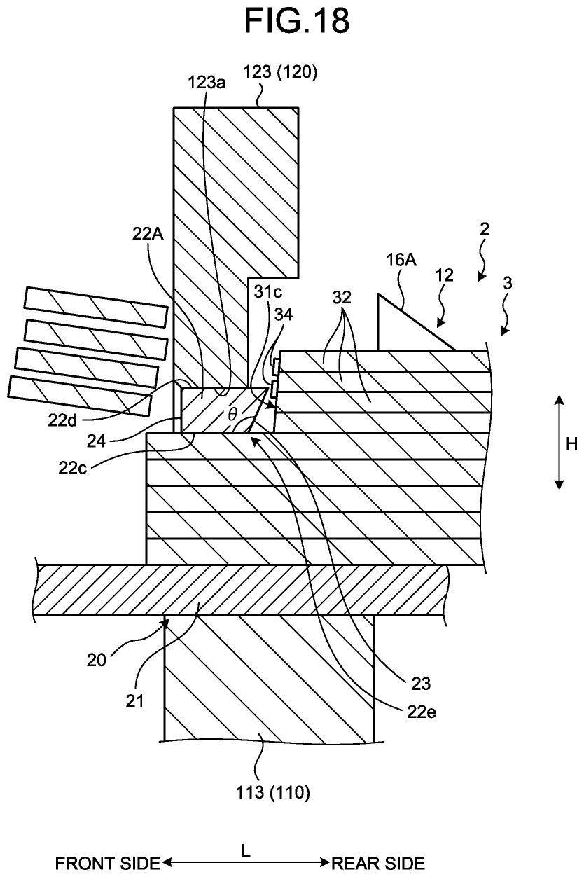

Referring to FIG. 18, a second modification of the first embodiment is described. FIG. 18 is a cross-sectional view for describing a cutting step according to the second modification of the first embodiment. As illustrated in FIG. 18, in a swaging portion 20 according to the second modification of the first embodiment, a side surface 23 of a first swaging piece 22A is inclined. The side surface 23 is a side surface of the first swaging piece 22A on the core wire crimping portion 12 side. The side surface 23 is inclined such that an angle θ of the edge portion 22e is obtuse. Specifically, the side surface 23 is inclined so as to approach the core wire crimping portion 12 along the first direction L from the inner side surface 22c to the outer side surface 22d of the first swaging piece 22A. The second swaging piece 22B is also provided with a side surface 23 similarly inclined.

The side surface 23 compresses the end portions of the cut element wires 32 to promote sliding movement of the element wires 32. The side surface 23 slidingly moves on the distal end surfaces of the cut element wires 32 to promote the bonding of the element wires 32. Thus, according to the second modification of the first embodiment, the electric performance of the electric wire with terminal 1 can be improved.

A side surface 24 of the first swaging piece 22A and the second swaging piece 22B on the side opposite to the side surface 23 may also be inclined. In this case, the orientation of the inclination of the side surface 24 may be opposite to the orientation of the inclination of the side surface 23. Specifically, the side surfaces 23 and 24 are inclined so as to approach each other along the first direction L from the outer side surface 22d to the inner side surface 22c.

### Second Embodiment

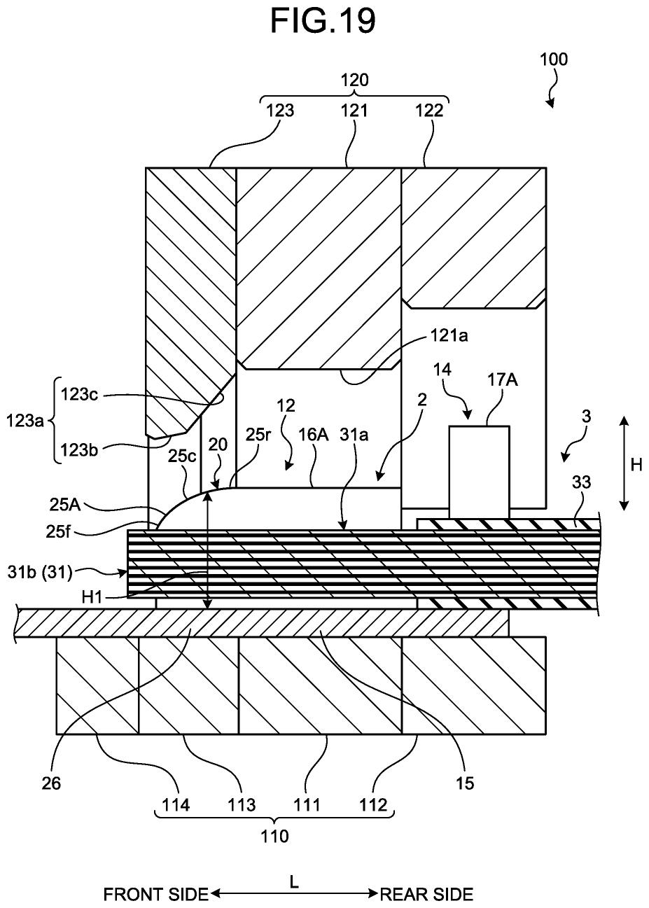

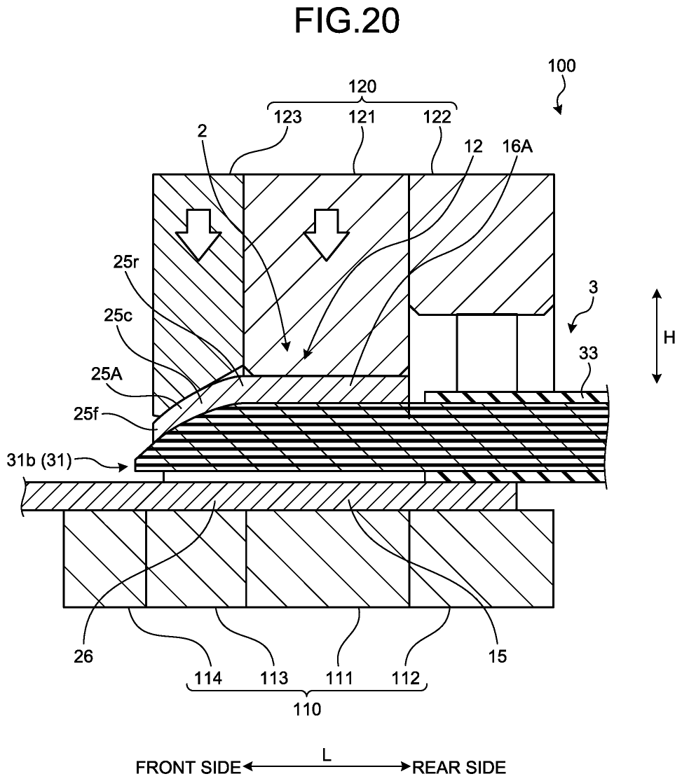

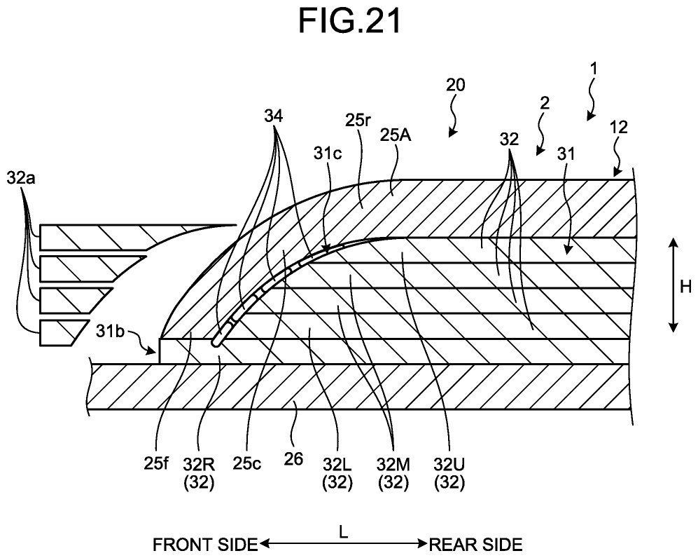

Referring to FIG. 19 to FIG. 21, a second embodiment is described. In the second embodiment, components having the same functions as those described in the first embodiment are denoted by the same reference symbols, and overlapping descriptions are omitted. FIG. 19 is a cross-sectional view of a terminal crimping apparatus and a crimp terminal according to the second embodiment. FIG. 20 is a cross-sectional view for describing a crimping step and a cutting step according to the second embodiment. FIG. 21 is a cross-sectional view for describing the cutting step according to the second embodiment. For example, the second embodiment is different from the above-mentioned first embodiment in that the core wire crimping portion 12 and the swaging portion 20 are integrally formed.

As illustrated in FIG. 19, the first swaging piece 16A of the core wire crimping portion 12 and a first swaging piece 25A of the swaging portion 20 are formed as an integral piece portion. The first swaging piece 25A is formed such that a height H1 thereof decreases toward the front side along the first direction L. Specifically, the first swaging piece 25A is formed such that a rear end portion 25r is the highest, a distal end portion 25f is the lowest, and a center portion 25c has an intermediate height. Similarly, a second swaging piece (not shown) of the swaging portion 20 and the second swaging piece 16B of the core wire crimping portion 12 are formed as an integral piece portion. The shape of the second swaging piece of the swaging portion 20 is similar to the shape of the first swaging piece 25A.

As illustrated in FIG. 19, the curved surface 123a of the third crimper 123 has a first face 123b and a second face 123c. The first face 123b is provided on the front side of the curved surface 123a. The second face 123c is provided on the rear side of the curved surface 123a. The first face 123b and the second face 123c are inclined with respect to the first direction L. The first face 123b and the second face 123c are inclined so as to be directed upward as approaching the first crimper 121 along the first direction L. In other words, the curved surface 123a is inclined such that the cross-sectional area increases as approaching the rear side along the first direction L. The inclination angle of the first face 123b is smaller than the inclination angle of the second face 123c. The third crimper 123 is inclined as described above, and is thus configured to compress a front part of the first swaging piece 25A with a strong compressing force as compared with a rear part of the first swaging piece 25A.

The electric wire 3 is installed on the crimp terminal 2 such that the end portion 31a of the core wire 31 is opposed to the bottom portion 15 of the core wire crimping portion 12 and a bottom portion 26 of the swaging portion 20. For example, the electric wire 3 is installed such that the distal end 31b protrudes to the front side from the swaging portion 20. The terminal crimping apparatus 100 implements the crimping step and the cutting step in parallel. Specifically, the first crimper 121 and the third crimper 123 integrally descend. As illustrated in FIG. 20, the first crimper 121 crimps the core wire crimping portion 12 to the core wire 31, and the third crimper 123 cuts the element wire 32 by winding the swaging portion 20 around the core wire 31.

As illustrated in FIG. 21, the first swaging piece 25A cuts the element wire 32 to remove the distal end portion 32a. In the element wire 32, for example, the removed distal end portion 32a is a portion that protrudes to the front side from the swaging portion 20. When the element wire 32 is cut, the cutting surface 31c is formed on the core wire 31. For example, the cutting surface 31c formed in the second embodiment is a surface inclined with respect to the first direction L. The cutting surface 31c is inclined toward the distal end 31b of the core wire 31 along the first direction L as approaching the bottom portion 26 of the swaging portion 20.

The inclined cutting surface 31c is formed in conformity to the shape of the first swaging piece 25A a height H1 (see FIG. 19) of which decreases toward the front side. At the cutting step, the rear end portion 25r of the first swaging piece 25A is first wound around the core wire 31, the center portion 25c is next wound around the core wire 31, and the distal end portion 25f is finally wound around the core wire 31. Thus, the rear end portion 25r first cuts an element wire 32U as the top layer, the center portion 25c next shears an element wire 32M as the intermediate layer, and the distal end portion 25f finally cuts an element wire 32L as the bottom layer. In this manner, the formed cutting surface 31c becomes an inclined surface as illustrated in FIG. 21.

The first swaging piece 25A pressurizes the end portion of the element wire 32 while cutting the element wire 32, so that the end portion of the element wire 32 slidingly moves with an end portion of an adjacent element wire 32. Because the element wires 32 slidingly move together, the element wires 32 adhere and are bonded together. In this manner, a bonding portion 34 is formed on at least the cutting surface 31c of the core wire 31. The first swaging piece 25A is swaged to the core wire 31 while covering the cutting surface 31c and the bonding portion 34. Similarly to the first swaging piece 25A, the second swaging piece of the swaging portion 20 forms the bonding portion 34 while cutting the element wire 32. Similarly to the first swaging piece 25A, the second swaging piece is swaged to the core wire 31 while covering the cutting surface 31c and the bonding portion 34.

As illustrated in FIG. 21, in the state in which the swaging is completed, the wire 32R, which is a part of the element wires 32 close to the bottom portion 26, is not cut but compressed by the swaging portion 20. In other words, the swaging portion 20 cuts most of the element wires 32 excluding the partial element wires 32R. The swaging portion 20 may cut element wires 32 located at the center of the core wire 31 or may cut at least a half of the element wires 32 similarly to the swaging portion 20 in the first embodiment.

As described above, the electric wire with terminal 1 according to the second embodiment includes the electric wire 3 and the crimp terminal 2. The electric wire 3 includes the core wire 31 having the element wires 32, and the covering that covers the core wire 31 in the state in which the end portion 31a of the core wire 31 is exposed. The crimp terminal 2 has the core wire crimping portion 12 and the swaging portion 20. The core wire crimping portion 12 is crimped to a part of the end portion 31a of the core wire 31 on the covering 33 side. The swaging portion 20 is swaged to a part of the end portion 31a of the core wire 31 closer to the distal end 31b than the core wire crimping portion 12.

The first swaging piece 16A of the core wire crimping portion 12 and the first swaging piece 25A of the swaging portion 20 are integrally formed. The second swaging piece 16B of the core wire crimping portion 12 and the second swaging piece of the swaging portion 20 are integrally formed. The core wire 31 has the cutting surface 31c formed by cutting a part of the element wires 32. The cutting surface 31c is covered by the swaging portion 20. Adjacent element wires 32 are bonded together at the cutting surface 31c. At the cutting surface 31c, the element wires 32 are bonded together and the electric resistance is reduced, and hence the electric performance of the electric wire with terminal 1 improves.

In the electric wire with terminal 1 in the second embodiment, the cutting surface 31c is a surface formed by cutting the element wires 32 by the swaging portion 20. Whether the element wires 32 have been cut by the swaging portion 20 can be confirmed by, for example, a trace left on the side surface and the like of the first swaging piece 25A. In the electric wire with terminal 1 in the second embodiment, the distal end of the element wire 32 may be sheared and deformed in a direction toward the bottom portion 26 of the swaging portion 20 along the cutting surface 31c.

The method of manufacturing an electric wire with terminal according to the second embodiment includes the crimping step and the cutting step. The crimping step is a step for crimping the core wire crimping portion 12 of the crimp terminal 2 to a part of the end portion 31a of the core wire 31 on the covering 33 side. The cutting step is a step for swaging the swaging portion 20 of the crimp terminal 2 to a part of the end portion 31a of the core wire 31 closer to the distal end 31b than the core wire crimping portion 12 to cut a part of the element wires 32 by the swaging portion 20.

Other Modifications

Other modifications are described. How the swaging pieces 16A and 16B are swaged to the core wire 31 is not limited to the form called “B crimp”. For example, the swaging pieces 16A and 16B may be wound around the bonding portions 34 such that the second swaging piece 16B overlaps the first swaging piece 16A. When the swaging pieces 16A and 16B are crimped by an overlap method, the swaging pieces 16A and 16B may be configured to integrally cover both the core wire 31 and the covering 33.

How the covering crimping portion 14 is swaged to the covering 33 is not limited to the form called “B crimp”. For example, the swaging pieces 17A and 17B may be crimped by an overlap method. The crimp terminal 2 is not necessarily required to have the covering crimping portion 14.

The contents disclosed in each of the above-mentioned embodiments and modifications can be appropriately combined for implementation.

The electric wire with terminal according to the embodiments and modifications includes: an electric wire including a core wire having element wires, and a covering that covers the core wire in a state in which an end portion of the core wire is exposed; and a crimp terminal including a core wire crimping portion crimped to a part of the end portion of the core wire on the covering side, and a swaging portion swaged to a part of the end portion of the core wire closer to a distal end than the core wire crimping portion. The core wire has a cutting surface formed by cutting a part of the element wires. The cutting surface is adjacent to the swaging portion, and is opposed to a side surface of the swaging portion in an axial direction of the electric wire. Adjacent element wires are bonded together at the cutting surface. Because adjacent element wires are bonded together at the cutting surface, the electric wire with terminal according to the present embodiments and modifications exhibits an effect that electric performance improves with a simple configuration.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electric wire with terminal, comprising:
an electric wire including a core wire having a plurality of element wires, and a covering that covers the core wire in a state in which an end portion of the core wire is exposed; and
a crimp terminal including a core wire crimping portion crimped to a part of the end portion of the core wire on the covering side, and a swaging portion swaged to a part of the end portion of the core wire closer to a distal end of the core wire than the core wire crimping portion, wherein
the core wire has a cutting surface formed by cutting a part of the element wires,
the cutting surface is adjacent to the swaging portion, and is opposed to a side surface of the swaging portion in an axial direction of the electric wire, and
adjacent ones of the element wires are bonded at the cutting surface.

2. The electric wire with terminal according to claim 1, wherein
a distal end of the element wire is sheared and deformed in a direction toward a bottom portion of the swaging portion along the cutting surface.

3. The electric wire with terminal according to claim 1, wherein
the cutting surface is a surface formed by cutting the element wire by the swaging portion.

4. The electric wire with terminal according to claim 2, wherein
the cutting surface is a surface formed by cutting the element wire by the swaging portion.

5. An electric wire with terminal, comprising:
an electric wire including a core wire having a plurality of element wires, and a covering that covers the core wire in a state in which an end portion of the core wire is exposed; and
a crimp terminal including a core wire crimping portion crimped to a part of the end portion of the core wire on the covering side, and a swaging portion swaged to a part of the end portion of the core wire closer to a distal end of the core wire than the core wire crimping portion, wherein
a swaging piece of the core wire crimping portion and a swaging piece of the swaging portion are integrally formed,
the core wire has a cutting surface formed by cutting a part of the element wires,
the cutting surface is covered by the swaging portion, and
adjacent ones of the element wires are bonded together at the cutting surface.

6. The electric wire with terminal according to claim 2, wherein
a distal end of the element wire is sheared and deformed in a direction toward a bottom portion of the swaging portion along the cutting surface.

7. The electric wire with terminal according to claim 3, wherein
the cutting surface is a surface formed by cutting the element wire by the swaging portion.

8. The electric wire with terminal according to claim 6, wherein
the cutting surface is a surface formed by cutting the element wire by the swaging portion.

9. A method of manufacturing an electric wire with terminal, the electric wire including a core wire having a plurality of element wires, and a covering that covers the core wire in a state in which an end portion of the core wire is exposed, the method comprising steps of:
crimping a core wire crimping portion of a crimp terminal to a part of the end portion of the core wire on the covering side; and
cutting a part of the element wires by a swaging portion by swaging the swaging portion of the crimp terminal to a part of the end portion of the core wire closer to a distal end than the core wire crimping portion.
